(19) United States
(12) Patent Application Publication
(10) Pub. No.: US 2021/0188702 A1
(43) Pub. Date: Jun. 24, 2021

(54) ETCHED GLASS SURFACES WITH HYDROPHOBIC ALKOXYORGANOSILANES

(71) Applicant: Hewlett-Packard Development Company, L.P., Spring, TX (US)

(72) Inventors: Kuan-Ting Wu, Taipei (TW); Hang Yan Yuen, Fort Collins, CO (US); Hui He, Fort Collins, CO (US)

(73) Assignee: Hewlett-Packard Development Company, L.P., Spring, TX (US)

(21) Appl. No.: 17/046,021

(22) PCT Filed: Sep. 14, 2018
(86) PCT No.: PCT/US2018/050982

§ 371 Date: Oct. 8, 2020

(51) Int. Cl. C03C 17/30; C03C 21/00; C03C 15/00

(52) U.S. Cl. CPC C03C 17/30; C03C 2217/76; C03C 15/00; C03C 21/002

(57) ABSTRACT

The present disclosure relates to an electronic display that can include a glass panel, an optically clear adhesive, and a backlight unit. The glass panel can have a glass surface that can be etched and can include a hydrophobic alkoxyorganosilane having a C10 to C18 alkyl chain covalently attached thereto. The optically clear adhesive can adhere the glass panel to the backlight unit.

### BACKGROUND

The use of electronic devices of all types continues to increase. Cellular phones, including smartphones, tablet computers, desktop computers and portable laptop computers continue to be used by many for personal, entertainment, and business purposes. All of these devices include an electronic display. In addition, electronic displays are being incorporated into household appliances such as refrigerators and washing machines. As the use electronic devices continues to rise, so does the demand for new and improved electronic displays for those devices.

### BRIEF DESCRIPTION OF THE DRAWING

FIG. 1 graphically illustrates a cross-sectional view of glass including a glass surface treated in accordance with examples of the present disclosure;

FIG. 2 graphically illustrates an example electronic display with a section thereof shown in cross-section in accordance with examples of the present disclosure; and

FIG. 3 is a flow diagram illustrating an example method of treating glass in accordance with examples of the present disclosure.

### DETAILED DESCRIPTION

The present disclosure relates to electronic displays, glass including a glass surface that is treated, and a method of treating glass. In one example, an electronic display can include a glass panel, an optically clear adhesive, and a backlight unit. The glass panel can have a glass surface that can be etched and can include a hydrophobic alkoxyorganosilane having a C10 to C18 alkyl chain covalently attached thereto. The optically clear adhesive can adhere the glass panel to the backlight unit. In another example, the electronic display can be configured as a liquid crystal display, an organic light-emitting diode display, a micro light-emitting diode display, a mini light-emitting diode display, an electrophoretic display, or a micro-electro-mechanical display. In yet another example, the glass panel can exhibit a minimum pencil hardness of 9H at the glass surface. In a further example, the glass surface can exhibit a specular reflection from about 5 to about 70. In one example, the glass surface can exhibit a water surface contact angle from about 75° to about 105°. In another example, the optically clear adhesive can include a polyacrylic, a polycarbonate, a cyclic olefin copolymer (COC), a polyester, or a combination thereof.

In another example, the present disclosure provides a glass including a glass surface that is etched, includes a hydrophobic alkoxyorganosilane having a C10 to C18 alkyl chain covalently attached to the glass surface, and exhibits a minimum pencil hardness of 9H. The glass can have a thickness from about 0.1 mm to about 0.7 mm. In one example, the hydrophobic alkoxyorganosilane can include a C10 to C18 alkyl chain that can be covalently attached to the glass surface at a concentration to provide a water surface contact angle from about 75° to about 105°. In another example, the glass surface can exhibit a specular reflection from about 5 to about 70.

In another example, a method of treating glass can include etching a glass surface in an acid bath, applying an emulsion to the glass surface, and heat curing the glass to form a treated glass surface that can be both etched and can include an alkoxyorganosilane covalently attached to the glass surface. The emulsion can include a continuous aqueous phase, a discontinuous organosilane phase including an alkoxyorganosilane present in the emulsion in an amount from about 0.5 wt % to about 10 wt %, and surfactant that can be present in the emulsion in an amount from about 0.3 wt % to about 5 wt %. The alkoxyorganosilane can be hydrophobic and can include a C10 to C18 alkyl chain. In one example, the acid bath can include water and an acid selected from hydrochloric acid, hydrofluoric acid, nitric acid, sulfuric acid, or a combination thereof. The acid can be present in the acid bath in an amount from about 1 wt % to 20 wt %, and the acid bath can be warmed to a temperature from about 30° C. to about 80° C. In another example, the alkoxyorganosilane can be selected from dodecyltrimethoxysilane, mercaptoundecyltrimethoxysilane, triethoxysilylundecanal, 11-aminoundecyltriethoxysilane, N-(2-aminoethyl)-11-undecyltrimethoxysilane, or a combination thereof. The surfactant can be anionic, for example, and can include sodium caseinate, sodium polyacrylate, sodium polyoxyethylene alkyl ether carboxylate, sodium dodecyl sulfate, or a combination thereof. In yet another example, applying can include warming the emulsion to a temperature from about 30° C. to about 65° C. and dipping the glass surface in the emulsion. In a further example, prior to etching the glass surface, the method can include chemically strengthening the glass in a potassium salt bath. In one example, the method can further include heating the potassium salt bath to a temperature ranging from 300° C. to 500° C.

It is noted that when discussing the electronic display, the (treated) glass, or the method herein, such discussions can be considered applicable to one another whether or not they are explicitly discussed in the context of that example. Thus, for example, when discussing a hydrophobic alkoxyorganosilane in the context of one of the electronic displays, such disclosure is also relevant to and directly supported in the context of the glass and/or the method, and vice versa. It is also understood that terms used herein will take on their ordinary meaning in the relevant technical field unless specified otherwise. In some instances, there are terms defined more specifically throughout or included at the end of the present disclosure, and thus, these terms are supplemented as having a meaning described herein.

Glass and Glass Panels

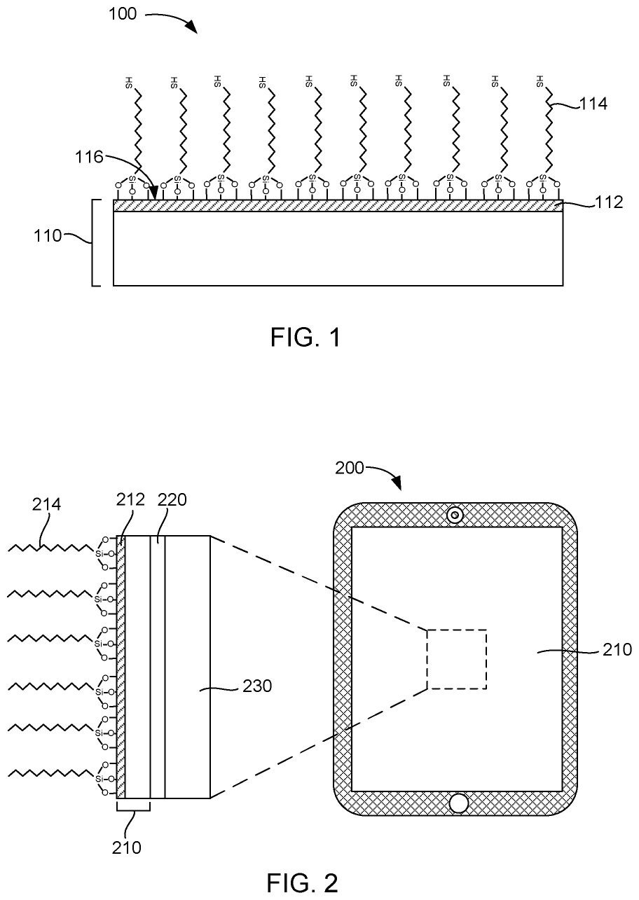

Glass, including a glass surface that can be treated in various ways, can have a variety of configurations. However, in examples herein, the glass can include a glass surface that may be etched and treated with a hydrophobic alkoxyorganosilane, and in some instances, the glass can be hardened. The glass can be, in one example, in the form of a glass panel. For example, as shown in FIG. 1, glass 100 is shown with a glass surface 116 that is etched 112 and includes a hydrophobic alkoxyorganosilane including a C10 to C18 alkyl chain 114 covalently attached to the glass surface. The hydrophobic alkoxyorganosilane can be covalently attached to the glass surface at a concentration to provide a water surface contact angle from about 75° to about 105°, for example. The concentration that can provide a water surface contact angle that can range from about 75° to about 105° can vary depending on the alkoxyorganosilane. However, an example concentration of hydrophobic alkoxyorganosilane that can provide the water surface contact angle from about 75° to about 105° can range from about 80° to about 95°. In further detail, the glass surface can exhibit a minimum pencil hardness value of about 8H, or a minimum pencil hardness of about 9H. To achieve this level of surface hardness, the glass can be treated as described hereinafter, as glass typically exhibits a pencil hardness from about 5H to about 7H.

The glass can be an antiglare glass, anti-fingerprint glass, ultra-thin glass, flat glass, cover glass, polished glass, tempered glass, float glass, toughened glass, and the like. Even in instances where the glass is an anti-glare glass initially, the etching described herein can further add to the anti-glare properties of the glass in some instances. In one example, the glass panel can be a cover glass, such as the outermost glass that may be present on an electronic display or other display device.

The thickness of the glass panel can vary. In one example, the glass (or glass panel) can have a thickness that can range from about 0.1 mm to about 2 mm, from about 0.1 mm to about 1.5 mm, from about 0.1 mm to about 1 mm, from about 0.1 mm to about 0.7 mm, from about 0.15 mm to about 0.65 mm, from about 0.1 mm to about 0.5 mm, or from about 0.3 mm to about 0.7 mm. In certain more specific examples where the glass is to be particularly thin for a specific application, such as for some types of electronic display glass covers, the glass can be from about 0.1 mm to about 0.7 mm, from about 0.15 mm to about 0.65 mm, from about 0.1 mm to about 0.5 mm, or from about 0.3 mm to about 0.7 mm.

Details regarding washing, etching, treating with hydrophobic alkoxyorganosilane, hardening, etc., are described in greater detail hereinafter.

Electronic Displays

The electronic display described herein can include a viewing surface from a variety of electronic devices. The viewing surface can be assembled to include a glass panel as described herein by applying the glass panel to a backlight unit, e.g., the balance of the electronic display, using an optical adhesive. Thus, a glass panel can be used, for example, as the display surface of an electronic display. FIG. 2 depicts a portion of an electronic display 200, for example a table, shown in cross-section (not to scale). The electronic display can include a glass panel 210, an optically clear adhesive 220, and a backlight unit 230. The glass panel can have a glass surface that can be etched 212 and can include hydrophobic alkoxyorganosilane including a C10 to C18 alkyl chain 214 covalently attached thereto. The optically clear adhesive can adhere the glass panel to the backlight unit.

The electronic display can be used in conjunction with any electronic device incorporating an electronic display. For example, the electronic display can be incorporated into a computer monitor, television, laptop, tablet, printer, smartphone, gaming device, virtual reality device, appliance, GPS system, vehicle interface, etc. In one example, the electronic display can be incorporated into a computer monitor, laptop, tablet, printer, or smartphone. In one example, the electronic display can be a computer monitor.

The type of electronic display is not particularly limited. Thus, the glass panel can be assembled with a backlight unit (which may include other layers or portions other than the light source) using an optically clear adhesive to form the electronic display. Examples of electronic displays can have a liquid crystal display (LCD); an electroluminescent display, e.g., an electro-luminescence (EL), a light-emitting diode (LED), a micro light-emitting diode, an organic light-emitting diode (OLED), etc.; a photoluminescent display, e.g., plasma display panel (PDP); or the like.

Optically Clear Adhesive

The electronic display can include an optically clear adhesive to adhere the glass panel to the backlight unit. The optically clear adhesive can be adhered to a surface of the glass that can be opposite an etched surface having the hydrophobic alkoxyorganosilane with a C10 to C18 alkyl chain of the glass panel. The optically clear adhesive can be applied between a portion of the glass panel and the backlight unit or can be applied to the entire glass panel and the backlight unit. As a note, when referring to the backlight unit, this can be a backlight assembly that includes a light source and a variety of layers that may typically be present as part of an electronic display, as described in greater detail hereinafter.

In one example, the optically clear adhesive can include a polyacrylic, a polycarbonate, a cyclic olefin copolymer (COC), a polyester, or a combination thereof. In another example, the optically clear adhesive can be a cyclic olefin copolymer. In another example, the optically clear adhesive can be a polyacrylic adhesive.

The optically clear adhesive can have a refractive index from about 1.48 to about 1.7, for example. In some examples, the optically clear adhesive can make up about 100 wt % of a polymeric adhesive, or can include additives, or can be applied with a solvent that is volatile or evaporable, for example. Typically, the polymeric adhesive, when dried, includes the polymeric adhesive component at from about 90 wt % to 100 wt %, from about 90 wt % to about 99.9 wt %, from about 95 wt % to about 99.7 wt %, or from about 90 wt % to about 98 wt %, for example. Other components that may be present after drying may include, for example, nanospheres, wetting agent, biocides, or a combination thereof. Some examples of wetting agents can include ethoxylated aliphatic alcohol, carboxylic esters, polyethylene glycol ester, polyoxyethylene glycol octylphenol ethers, or a combination thereof. Some examples of biocides can include hydrogen peroxide, potassium permanganate, glutaraldehyde, or a combination thereof.

In some examples, the optically clear adhesive layer can have a thickness from about 5 μm to about 100 μm, from about 10 μm to about 50 μm, or from about 15 μm to about 30 μm.

Backlight Unit

The backlight units shown and described herein can include an electrically produced visual display unit that emits light, including simple static light display boxes, but more typically, electronic visual displays which can present electronically transmitted images, text, video, etc. For clarity, a backlight unit includes any lighting unit that emits light and the light is emitted through the glass panel. Thus, by this definition, a backlight unit can emit light through the glass panel directly therethrough, or can be an edge lit unit, for example. The glass panels of the present disclosure can be assembled with the backlight unit, e.g., electronic visual display, as the display surface thereof, for example. Examples of the electronic visual displays can include light emitting components of desktop computer monitors, laptop monitors, tablet monitors, smartphone monitors, gaming system monitors, television monitors, digital signage monitors, etc. Backlight units can likewise include complete display systems (every portion of the electronic visual display except the glass panel and optically clear adhesive, which may be used to assemble the viewing surface of the electronic display), or can include just the backlight associated with the display system. Examples of backlight units that can include just the backlight architecture or even more complete assemblies of a backlight unit include a liquid crystal display (LCD) emitter; an electroluminescent emitter, e.g., electro-luminescence (EL), light-emitting diode (LED), mini light-emitting diode (Mini-LED), organic light-emitting diode (OLED), etc.; a photoluminescent emitter, e.g., plasma display panel (PDP); or the like. In one example, the backlight unit can include an LED unit, such as an LED edge-lit unit or an LED direct-lit unit.

Methods of Treating Glass

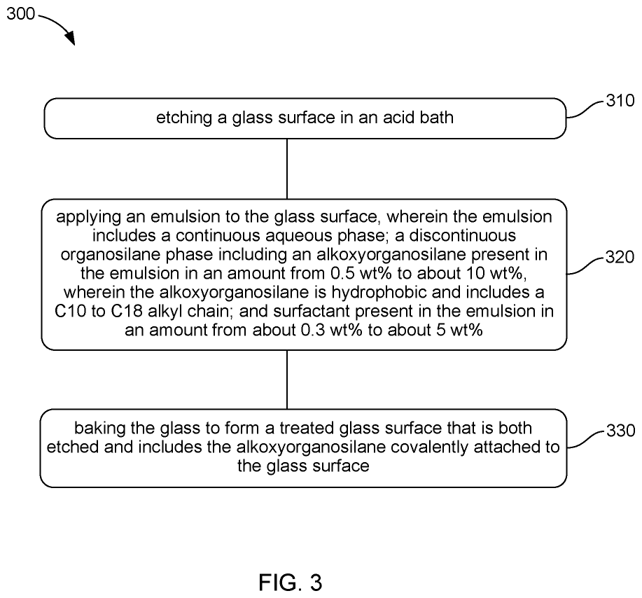

The present disclosure also extends to methods of treating glass. The glass, in one example, can be a glass panel that can be incorporated into electronic displays described herein. Thus, the details related to the glass panel for the electronic display and the glass details described above are directly relevant to the present method. Thus, FIG. 3 provides a flowchart of one example method 300 of treating glass. The method can include etching 310 a glass surface in an acid bath, applying 320 an emulsion to the glass surface, and heat curing 330 the glass to form a treated glass that can be etched and can include an alkoxyorganosilane covalently attached to the glass surface. The emulsion can include a continuous aqueous phase, a discontinuous organosilane phase, and surfactant. The discontinuous organosilane phase can include an alkoxyorganosilane present in the emulsion in an amount from about 0.5 wt % to about 10 wt % and can be hydrophobic and can include a C10 to C18 alkyl chain. The surfactant can be present in the emulsion in an amount from about 0.3 wt % to about 5 wt %. The surfactant can be an anionic surfactant in one example. In further detail, the method can also include chemically strengthening a glass surface, as well as washing the glass in preparation for various stages and between various stages.

Chemically Strengthening Glass

In examples of the present disclosure, the glass or glass panels described herein can be chemically strengthened. For example, chemical strengthening can involve submerging the glass panel in an about 0.5 wt % to about 3 wt % potassium salt solution at a temperature that can range from about 300° C. to about 500° C. for about 1 to about 10 minutes. In other examples, the potassium salt solution can have a concentration from about 1 wt % to 2.5 wt %, and can be heated to about 350° C. to about 450° C. for about 3 to about 5 minutes. In one example, the potassium salt solution can include potassium nitrate, potassium chloride, potassium sulfate, or a combination thereof. In another example, the potassium salt solution can include potassium nitrate.

With respect to potassium salt strengthening in particular, the chemical strengthening can occur as potassium ions in the potassium salt replace sodium ions on a glass surface of the glass panel. Potassium ions are larger than sodium ions and therefore can fill gaps that otherwise surround sodium ions, which can lead to compression or hardening of the glass, particularly at the surface. In one example, a chemically strengthened glass panel can have a surface compression strength that can range from about 700 MPa to about 1,000 MPa, or from about 750 MPa to about 950 MPa. Compression strength can be measured by universal tensile strength testing machines.

Another way to measure the hardness of the glass can be by determining pencil hardness. The glass treated in accordance with the present disclosure can have, for example, a minimum pencil hardness of about 8H, e.g., 8H, 9H, and harder than 9H at a surface. In other examples, the treated glass can have a minimum pencil hardness of about 9H, e.g., 9H and harder than 9H. As a practical matter, the highest number on the pencil hardness scale is 9H, so it is understood that when a surface has a minimum pencil hardness of about 8H, that would include all hardness values from 8H up to maximum hardness. A minimum pencil hardness of about 9H includes a hardness of 9H up to maximum hardness, e.g., measured at 9H but including hardness beyond 9H, for example. In general, an untreated glass surface can have a pencil hardness value of about 5H to about 7H. Pencil hardness values can be measured using a hardness scale and can refer to the ability of a surface to resist scratching. Pencil hardness can be tested by ASTM D 3363 (Standard Test Method for Film Hardness). Essentially, the standard test method includes the following details: Pencil type: 6B-5B-4B-2B-B-HB-F-H-2H-3H-4H-5H-6H-7H-8H-9H (brand: Mitsubishi) with 6B being softest and 9H being hardest; Test Protocol: Force loading at 750 g; drawing lead sharpened; substrate placed on a level, firm, horizontal surface; starting with the hardest lead, hold the pencil or lead in holder firmly with the lead against the substrate layer at a 45° angle (point away from the operator) and push away from the operator; allow the load weight to apply uniform pressure downward and forward as the pencil is moved to either cut or scratch the film or to crumble the edge of the lead (length of stroke to be ¼ inch (6.5 mm); repeat process down the hardness scale until a pencil is found that will not scratch or gouge the substrate; the hardest pencil that does not scratch or gouge the substrate is then considered the pencil hardness of the substrate.

Etching Glass in Acid Bath

The glass and glass panels described herein can be surface-etched. The etched surface can provide a roughness to a surface of the glass panel that provides anti-glare properties. In one example, glass or a glass panel can be etched by soaking the glass for about 1 minute to about 60 minutes or from about 3 minutes to about 40 minutes in an acid bath at an acid concentration of about 1 wt % to about 20 wt %, for example. In one example, the acid bath can include water and an acid such as hydrochloric acid, nitric acid, hydrofluoric acid, or sulfuric acid. In some examples, the acid can be present in the acid bath at a concentration from about 2 wt % to about 20 wt %, from about 3 wt % to about 15 wt %, about 5 wt % to about 20 wt %, about 7 wt % to about 15 wt %, or from about 1 wt % to about 10 wt %.

In some examples, the acid bath can be heated to a temperature ranging from about 30° C. to about 80° C. prior to placing the glass therein. In yet other examples, the acid bath can be heated to a temperature ranging from about 30° C. to about 80° C. prior to and during soaking of the glass panel. In further examples, the acid bath can be heated to a temperature ranging from about 40° C. to about 70° C., from about 30° C. to about 60° C., or from about 45° C. to about 65° C., prior to and during soaking of the glass panel. Heating the acid bath can reduce the formation of hills and valleys on the glass surface that may result from etching a glass panel in an acid bath.

The etching can remove a portion of the surface layers of the glass panel. In some examples, etching can reduce the amount of sodium ions, calcium ions, aluminum ions, or a portion thereof at the glass surface. This can expose more surface area to which the hydrophobic alkoxyorganosilanes with C10 to C18 alkyl chain can become covalently attached. The etching can also reduce the thickness of the glass panel. In one example, the glass panel can have a thickness reduction from about 0.05 mm to about 0.1 mm. In some examples, the etching may not negatively impact relative transmittance of the glass surface.

Upon etching, the glass panel can also exhibit a measurable specular reflection, which is a mirror-like reflection of light by a glass surface. Specular reflection can be measured by Cary 630 FTIR. In one example, a glass surface of the glass panel can exhibit a specular reflection ranging from about 5 to about 70. In another example, a glass surface of the glass panel can exhibit a specular reflection from about 20 to about 60. In further examples, a glass surface of the glass panel can exhibit a specular reflection from about 25 to about 55, from about 15 to about 65, or from about 30 to about 70.

Applying Emulsion to Glass Surface

The glass or glass panel can also be treated to include a hydrophobic alkoxyorganosilane with a C10 to C18 alkyl chain that can be covalently attached to a surface of the glass panel. In one example, the alkoxyorganosilane can be adhered to the etched surface of the glass panel. In some examples, the alkoxyorganosilane can be a monoalkoxyorganosilane, a dialkoxyorganosilane, or a trialkoxyorganosilane. FIGS. 1 and 2 depict trialkoxysilanes with three points of attachment to the glass surface and the organo group is represented by the C10 to C18 alkyl chain extending from the silicon atom. One example, as shown in FIG. 1, includes thiol group at a terminal end of the alkyl chain. Another example, as shown in FIG. 2, includes an alkyl chain without a functional terminal group, e.g., terminates with a methyl group. Other terminal groups can be used, such as an amine or amino group. Thus, in one example, the alkoxyorganosilane can include dodecyltrimethoxysilane, mercaptoundecyltrimethoxysilane, triethoxysilylundecanal, 11-aminoundecyltriethoxysilane, N-(2-aminoethyl)-11-undecyltrimethoxysilane, or a combination thereof. In another example, the alkoxyorganosilane can be dodecyltrimethoxysilane. In yet another example, the alkoxyorganosilane can be mercaptoundecyltrimethoxysilane. In a further example, the alkoxyorganosilane can include a C11 to C16 alkyl chain, or a C12 to C14 alkyl chain. Furthermore, though the alkyl chain may be straight-chained alkyl, it may also be branched, for example.

The alkoxyorganosilane can be covalently bonded to a surface of the glass panel at Si—O groups. The covalent bonds can occur at one, two, or three oxygen atoms that can be attached to the silicon of the alkoxyorganosilane and covalently bonded to the glass surface, such as to surface hydroxyl groups that may be present thereon. The covalent bonds can be formed at all or a portion of the oxygen(s) on the alkoxyorganosilane (except for where the C10 to C18 alkyl chain is attached to the silicon atom). Furthermore, there may be multiple C10 to C18 alkyl chains to the silicon atom, such as may be permissible with monoalkoxyorganosilane and dialkoxyorganosilanes.

With the alkoxyorganosilane with C10 to C18 alkyl chains attached to the glass (or glass panel) at the etched surface, the glass surface can have a water surface contact angle that can range from about 75° to about 105°. As used herein a water surface contact angle refers to the angle formed by the intersection of the liquid-solid interface and the liquid-vapor interface and can be measured by a contact angle analyzer. When an interface exists between a liquid and a solid, the angle between the surface of the liquid and the outline of the contact surface is described as the contact angle θ (lower case theta). The contact angle (wetting angle) is a measure of the wettability of a solid by a liquid. In one example, a glass surface of the glass panel can exhibit a water surface contact angle from about 80° to about 105°. In another example, a glass surface of the glass panel can exhibit a water surface contact angle from about 75° to about 95°. In yet another example, a glass surface of the glass panel can exhibit a water surface contact angle from about 85° to about 100°.

With respect to details about the emulsion per se, the emulsion can include a continuous aqueous phase, a discontinuous organosilane phase, and surfactant. The continuous aqueous phase can include water, and may include other solvents or components that are soluble and/or miscible with the water. In one example, the water can be deionized and/or purified. The discontinuous organosilane phase can include the hydrophobic alkoxyorganosilane with the C10 to C18 alkyl group present in the emulsion in an amount from about 0.5 wt % to about 10 wt %. In some examples, the hydrophobic alkoxyorganosilane can be present at from about 2 wt % to about 8 wt %, from about 1 wt % to about 7 wt %, or from about 3 wt % to about 9 wt %.

The surfactant can be used to promote a dispersion of the discontinuous phase in the continuous phase, with droplet sizes ranging from about 0.5 μm to about 10 μm, for example. For example, the surfactant can reduce surface tension and can help disperse the hydrophobic alkoxyorganosilane in the aqueous phase of the emulsion. The anionic surfactant can be an anionic surfactant, and can include, for example, sodium caseinate, sodium polyacrylate, sodium polyoxyethylene alkyl ether carboxylate, sodium dodecyl sulfate, or a combination thereof. The surfactant can be present in the emulsion, for example, at from about 0.3 wt % to about 5 wt %, or from about 0.5 wt % to about 4 wt %, or from about 0.5 wt % to about 2 wt %.

If allowed to rest, in some instances, the emulsion may separate into phases instead of remaining as a fine dispersion of hydrophobic droplets. In such an instance, the emulsion can be agitated prior to dipping the glass surface in order to disperse the hydrophobic droplets into the continuous phase of the aqueous vehicle. In one example, the emulsion can be agitated manually by shaking, and/or can be placed in a centrifuge at from about 200 rpm to about 500 rpm. In another example, the emulsion can be agitated and/or centrifuged at from about 300 rpm to about 400 rpm.

Regardless of whether or not agitation and/or centrifugation is used or applicable for use with respect to a specific emulsion formulation, in some examples, the emulsion can be heated prior to dipping the glass surface in the emulsion. In one example, the emulsion can be heated to a temperature ranging from about 30° C. to about 65° C., from about 40° C. to about 60° C., or from about 45° C. to about 55° C. The hydrophobic alkoxyorganosilane with C10 to C18 alkyl group can be covalently attached to the etched glass surface by applying an emulsion of the hydrophobic component (in an continuous aqueous medium) to the glass surface by dipping the glass surface in the emulsion for a period of time ranging from about 15 seconds to about 2 minutes. In yet another example, the glass surface can be dipped in the emulsion for a period of time ranging from about 30 seconds to about 1 minute. In further detail, the glass can be dipped into the emulsion one time or multiple times. During dipping, the hydrophobic alkoxyorganosilane including a C10 to C18 alkyl chain can become covalently attached to the etched glass surface of the glass or glass panel.

Washing Glass

The glass panel and/or the glass surface can be washed at various points during the preparation process. The washing can occur prior to chemically strengthening a glass surface, prior to etching the glass surface in an acid bath, prior to applying an emulsion to the glass surface, prior to heat curing the glass panel, between hardening and etching, between hardening and applying the emulsion, between etching and applying the emulsion, between applying the emulsion and applying to a backlight unit with an optically clear adhesive, etc.

The washing can involve soaking the glass panel for about 1 to about 20 minutes in water, from about 2 to about 15 minutes in water, or from about 5 to about 10 minutes in water. The water can be deionized in one example. In another example, the water can further include about 0.5 wt % to about 10 wt %, from about 1 wt % to about 5 wt %, or from about 1 wt % to about 3 wt % detergent. The detergent can be any commercially available detergent. Commercially available examples can include RBS IND 700 and RBS IND 740, both available from Chemical Products R. Borghgraef S. A. (RBS), Germany.

In further detail, washing can further include introducing ultrasonic energy and/or heat to the water bath. The temperature can range from about 30° C. to about 100° C., from about 40° C. to about 70° C., from about 50° C. to about 60° C., or from about 45° C. to about 65° C. The ultrasonic energy can be introduced at a frequency and power level from about 10 kHz to about 400 kHz, and from about 25 kHz to about 300 kHz, respectively.

Heat Curing Glass

After etching and applying the hydrophobic alkoxyorganosilane to the surface of the glass or glass panel, and in some instances after hardening/strengthening and/or washing, heat curing (e.g., baking) the glass can be carried out using an oven, such as a hot air circulation oven. “Heat curing” can be defined as applying elevated temperatures (above ambient, e.g., 25° C.) to remove fluids from surface. Example temperatures for heat curing can be from about 80° C. to 180° C., from about 110° C. to about 150° C., from about 115° C. to about 145° C., or from about 120° C. to about 140° C. Baking or heat curing times can be for a period of time of about 10 minutes to 1 hour, from about 15 minutes to about 45 minutes, or from about 20 minutes to about 35 minutes, for example. In some examples, a spray can be used to remove any liquid droplets on the glass panel prior to heat curing the glass panel.

### Definitions

It is noted that, as used in this specification and the appended claims, the singular forms “a,” “an,” and “the” include plural referents unless the content clearly dictates otherwise.

The term “about” as used herein, when referring to a numerical value or range, allows for a degree of variability in the value or range, for example, within 5% or other reasonable added range breadth of a stated value or of a stated limit of a range. The term “about” when modifying a numerical range is also understood to include the exact numerical value indicated, e.g., the range of about 1 wt % to about 5 wt % includes 1 wt % to 5 wt % as an explicitly supported sub-range.

As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary.

Concentrations, dimensions, amounts, and other numerical data may be presented herein in a range format. It is to be understood that such range format is used merely for convenience and brevity and should be interpreted flexibly to include the numerical values explicitly recited as the limits of the range, and also to include all the individual numerical values or sub-ranges encompassed within that range as if each numerical value and sub-range is explicitly recited. For example, thickness from about 0.1 mm to about 0.5 mm should be interpreted to include the explicitly recited limits of 0.1 mm to 0.5 mm, and to include thicknesses such as about 0.1 mm and about 0.5 mm, as well as subranges such as about 0.2 mm to about 0.4 mm, about 0.2 mm to about 0.5 mm, about 0.1 mm to about 0.4 mm etc.

The following illustrates examples of the present disclosure. However, it is to be understood that the following is illustrative of principles of the present disclosure. Numerous modifications and alternative methods, compositions, devices, systems, etc., may be used or devised without departing from the present disclosure. The appended claims are intended to cover such modifications and arrangements.

### EXAMPLES

### Example 1—Preparation of a Glass Panel for an Electronic Display

An example glass panel for an electronic device is prepared as follows:
1) A 0.7 mm thick cover glass panel having a water surface contact angle of about 55° is washed for 10 minutes in a 2 wt % aqueous solution of RBS IND 700 (detergent) and heated to 60° C.
2) The cover glass panel is submerged into a chemical strengthening treatment solution that includes water and 3 wt % potassium nitrate that is heated to 400° C.
3) The cover glass panel is washed again using the same solution and methodology as describe in 1) above.
4) The cover glass is etched for 20 minutes in an acid bath including a 3 wt % hydrochloric acid and 6 wt % nitric acid at a temperature of 50° C.
5) The cover glass panel is washed again using the same solution and methodology as describe in 1) above.
6) An emulsion is prepared that includes a continuous aqueous phase, a discontinuous organosilane phase, and surfactant. The discontinuous organosilane phase is dodecyltimethoxysilane and is present in the emulsion at about 10 wt %. The surfactant is sodium caseinate and is present in the emulsion at about 1 wt %. The continuous phase makes up the balance and is deionized water. Once prepared, the emulsion is agitated and centrifuged at about 400 RPM prior and heated to about 50° C.
7) The cover glass panel described in 5) above is then dipped in the emulsion prepared in 6) above for 60 seconds and then removed.
8) The cover glass is then baked for 20 minutes in a hot air circulation oven at 130° C.

The finished glass panel is thus etched, has a thickness ranging from 0.6 mm to 0.65 mm, has dodecyltimethoxysilane bound to a surface of the glass panel, and has a water surface contact angle of about 95°. The finished glass panel is capable of passing a Taber abrasion test as defined by a 250 g weight, 1″ stroke length, and 40 cycles/minute speed, and has a minimum pencil hardness value of 9H.

### Example 2—Assembly of an Electronic Display

A finished glass panel as prepared in Example 1 is adhered to a liquid crystal display backlight unit (which includes all components of the electronic display except for the display surface) using a polyacrylic optically clear adhesive having a thickness of about 30 μM. The glass panel operates as the display surface, and is hydrophobic and hardened for abrasion resistance as mentioned in Example 1. As part of an electronic display, the glass panel surface also exhibits a specular reflection of about 15. The backlight unit includes a light source, polarizing filters, electrodes, a liquid crystal layer, etc.

What has been described and illustrated herein is an example of the disclosure along with some of its variations. The terms, descriptions, and figures used herein are set forth by way of illustration and are not meant as limitations. Many variations are possible within the disclosure, which is intended to be defined by the following claims—and their equivalents—in which all terms are meant in their broadest reasonable sense unless otherwise indicated.

What is claimed is:

1. An electronic display, comprising:
a glass panel having a glass surface that is etched and includes a hydrophobic alkoxyorganosilane including a C10 to C18 alkyl chain covalently attached thereto;
an optically clear adhesive; and
a backlight unit, wherein the optically clear adhesive adheres the glass panel to the backlight unit.

2. The electronic display of claim 1, configured as a liquid crystal display, an organic light-emitting diode display, a micro light-emitting diode display, a mini light-emitting diode display, an electrophoretic display, or a micro-electro-mechanical display.

3. The electronic display of claim 1, wherein the glass panel exhibits a minimum pencil hardness of 9H at the glass surface.

4. The electronic display of claim 1, wherein the glass surface exhibits a specular reflection from about 5 to about 70.

5. The electronic display of claim 1, wherein the glass surface exhibits a water surface contact angle from about 75° to about 105°.

6. The electronic display of claim 1, wherein the optically clear adhesive includes a polyacrylic, a polycarbonate, a cyclic olefin copolymer (COC), and a polyester, or a combination thereof.

7. Glass comprising a glass surface, wherein the glass surface:
is etched,
includes a hydrophobic alkoxyorganosilane including a C10 to C18 alkyl chain covalently attached to the glass surface, and
exhibits a minimum pencil hardness of 9H; and
wherein the glass has a thickness from about 0.1 mm to about 0.7 mm.

8. The glass of claim 7, wherein the hydrophobic alkoxyorganosilane including a C10 to C18 alkyl chain is covalently attached to the glass surface at a concentration to provide a water surface contact angle from about 75° to about 105°

9. The glass of claim 7, wherein the glass surface exhibits a specular reflection from about 5 to about 70.

10. A method of treating glass comprising:
etching a glass surface in an acid bath;
applying an emulsion to the glass surface, wherein the emulsion comprises:
a continuous aqueous phase,
a discontinuous organosilane phase including an alkoxyorganosilane present in the emulsion in an amount from about 0.5 wt % to about 10 wt %, wherein the alkoxyorganosilane is hydrophobic and includes a C10 to C18 alkyl chain; and
surfactant present in the emulsion in an amount from about 0.3 wt % to about 5 wt %; and
heat curing the glass to form a treated glass surface that is both etched and includes the alkoxyorganosilane covalently attached to the glass surface.

11. The method of treating glass of claim 10, wherein the acid bath comprises water and an acid selected from hydrochloric acid, hydrofluoric acid, nitric acid, sulfuric acid, or a combination thereof, wherein the acid is present in the acid bath in an amount from about 1 wt % to 20 wt %, and the acid bath warmed to a temperature from about 30° C. to about 80° C.

12. The method of treating glass of claim 10, wherein the alkoxyorganosilane is selected from dodecyltrimethoxysilane, mercaptoundecyltrimethoxysilane, triethoxysilylundecanal, 11-aminoundecyltriethoxysilane, N-(2-aminoethyl)-11-undecyltrimethoxysilane, or a combination thereof, and wherein the surfactant is an anionic surfactant including sodium caseinate, sodium polyacrylate, sodium polyoxyethylene alkyl ether carboxylate, sodium dodecyl sulfate, or a combination thereof.

13. The method of treating glass of claim 10, wherein applying include warming the emulsion to a temperature from about 30° C. to about 65° C. and dipping the glass surface in the emulsion.

14. The method of treating glass of claim 10, wherein prior to etching the glass surface, the method includes chemically strengthening the glass in a potassium salt bath.

15. The method of treating glass of claim 14, further comprising heating the potassium salt bath to a temperature ranging from 300° C. to 500° C.
